(19) United States
(12) Patent Application Publication
(10) Pub. No.: US 2017/0228602 A1
(43) Pub. Date: Aug. 10, 2017

(54) METHOD FOR DETECTING HEIGHT

(71) Applicant: HELLA KGaA Hueck & Co., Lippstadt (DE)

(72) Inventor: Marko STEFANOVIC, Berlin (DE)

(73) Assignee: HELLA KGaA Hueck & Co., Lippstadt (DE)

(21) Appl. No.: 15/423,781

(22) Filed: Feb. 3, 2017

(30) Foreign Application Priority Data
Feb. 4, 2016 (DE) 10 2016 201 741.1

(51) Int. Cl. G06K 9/00; G01B 11/14; G06T 7/593; G01B 11/06

(52) U.S. Cl. CPC G06K 9/00771; G01B 11/0608; G01B 11/14; G06T 7/593; G06T 2207/10028; G06T 2207/10012; G06T 2207/30242

(57) ABSTRACT

The invention relates to a method for determining the height of an arrangement of an apparatus for sensing and, in particular, counting moving objects by means of a distance sensor, the apparatus having the distance sensor, the sensor generating distance data, in particular as the distance between the apparatus and an environment of the apparatus, which are evaluated in order to automatically determine the height of the arrangement of the apparatus.

### TECHNICAL FIELD

The invention relates to a method for detecting the height, in particular of an apparatus for sensing and/or counting moving objects such as moving persons, in particular.

### PRIOR ART

Counting movable objects is important in many areas of technology and daily life. For example, a shopkeeper is interested in finding out how many visitors visit his shop within a given period, where they are located in the shop and how long they remain there.

Apparatuses for detecting and, for example, counting moving objects such as moving persons, in particular, have been disclosed, which apparatuses are installed in an entrance area of the shop and acquire and evaluate different data in order to count entering or exiting moving objects, for example. Such apparatuses are also known, for example, for means of transport because it is also interesting, in the case of public means of transport in particular, to know how many passengers and what type of passengers, for instance children or adults, have been transported.

The apparatus for sensing and/or counting moving objects can also be used as a person monitoring device or a person counting device, in particular. In this case, the apparatus may use a stereo camera. In order to be able to sense and count selected moving objects, for example persons, these objects, for example persons, must first of all be detected and distinguished from other, unimportant objects. A feature which identifies an object such as a person is the size. The size is therefore a feature which is suitable for detecting objects such as persons and distinguishing them from low flat objects such as the floor, boxes, etc., for example.

A stereo camera used provides the necessary technology for determining, in particular calculating, three-dimensional information from an observed scene. The size of recorded objects can also be determined from the 3-D point cloud determined by a stereo camera.

In this case, the size of objects or persons is defined as the distance between the highest visible point on the object or person and the floor. The floor therefore has a size of 0 by definition.

However, in order to be able to correctly determine the size of objects or persons, knowledge of the height of the arrangement of the apparatus is important. Knowledge of the angular position of the arrangement of the apparatus is also important in order to be able to evaluate the recorded data.

In this case, the person installing the apparatus usually has to manually accurately determine the height after installation, which is not always carried out carefully, which results in errors in the result from the apparatus. It is also rather cumbersome to manually determine height, which is time-consuming and therefore often is not carried out accurately enough or is not carried out at all.

### Description of the Invention, Object, Achievement, Advantages

The object of the invention is to provide a method for detecting the height, in particular of an apparatus for sensing and/or counting, in particular, moving objects such as moving persons, in particular, which method can be used to determine the height of the apparatus automatically and reliably.

The object with respect to the method is achieved with the features of claim 1.

One exemplary embodiment of the invention relates to a method for determining the height of an arrangement of an apparatus for sensing and, in particular, counting moving objects by means of a distance sensor, the apparatus having the distance sensor, the sensor generating distance data, in particular as the distance between the apparatus and an environment of the apparatus, which are evaluated in order to automatically determine the height of the arrangement of the apparatus. This makes it possible to automatically determine the height of the arrangement or the installation height of the apparatus, in which case this can be carried out during installation, for example, and the data can be adopted for further use of the apparatus. This avoids the situation in which the determination of the height of the arrangement is forgotten and is incorrectly carried out, which could result in errors during further use of the apparatus.

A distance sensor is advantageously a sensor which acquires distance data in the room, that is to say, in particular, provides distance data relating to objects or all objects with a predefined resolution between itself and the respective object.

It is particularly advantageous if the distance sensor senses at least one part of a floor above which the apparatus is arranged. As a result, the distance to the apparatus is the distance to the floor, which needs to be determined in order to determine the height.

It is also advantageous if the apparatus senses a minimum portion of a floor in the monitoring region above which the apparatus is arranged. The detection of the floor and its distinction from other objects makes it possible here to determine the height as the distance.

In this case, it is particularly advantageous if the distance sensor generates, in successive recording cycles, distance data which are evaluated in order to automatically determine the height of the arrangement of the apparatus. This makes it possible to improve the quality of the acquired distance data and therefore the determination of the height. In this case, it is particularly advantageous if distance data relating to the same environment of the apparatus are recorded in successive recording cycles. This makes it possible to minimize noise and measurements of moving elements.

It is also particularly advantageous if a plurality of measured distance data items are evaluated in order to determine the height of the arrangement of the apparatus. This makes it possible to determine the height without previous knowledge of the location of the floor. It is also advantageous if all measured distances are investigated.

It is also advantageous if the distance data are determined taking into account the at least one angle at which the apparatus is fitted. This is particularly advantageous when there is at least one angle with a value which is not equal to 0 with respect to the installation plane. The installation plane is a plane which runs parallel to the floor plane and runs through the sensor. The sensor therefore has the height of 0 relative to this plane. If the floor is not inclined, the installation plane corresponds to a horizontal. If the sensor is installed in such a manner that it is directed precisely vertically downwards, all angles with respect to the installation plane correspond to 0 degrees and the sensor plane therefore corresponds to the installation plane. The consideration of the at least one angle at which the apparatus is fitted when determining the distance data has the advantage that it is ensured that heights which are at the same distance from the installation plane amount to the same value within the distance data. Therefore, objects of the same size also have the same height value in the distance data. In this case, the angle can be advantageously determined by means of an acceleration sensor.

Alternatively, the angle can also be manually captured. This is particularly advantageous when the floor is inclined, that is to say does not correspond to the horizontal, with the result that the angle measured by the acceleration sensor does not correspond to the actual angle with respect to a floor plane.

It is also advantageous if the frequency of the measured distance data is evaluated in order to determine the height of the arrangement of the apparatus. In this case, it is then advantageously possible to generate statistics from which the height can be determined. In particular, statistics for the frequency of the measured distance data for the respectively determined distances or distance ranges with respect to the sensor or installation plane can be generated, from which statistics the height can be determined.

It is also advantageous if a plurality of measured maximum distance data items are evaluated. As a result, the distance to the apparatus or to the sensor or installation plane is the greatest distance to the floor, which needs to be determined in order to determine the maximum height as the distance.

It is also advantageous if the frequency of the measured maximum distance data is evaluated in order to determine the height of the arrangement of the apparatus. In this case, it is then likewise advantageously possible to generate statistics from which the height can be determined. In particular, statistics for the frequency of the measured maximum distance data for the respective determined maximum distances or distance ranges with respect to the sensor or installation plane can be generated, from which statistics the height can be determined.

It is also advantageous if the frequency of the maximum distance data is evaluated in relation to the frequency of other distance data with lower values in order to determine the height of the arrangement of the apparatus. In this case, the distance data advantageously contain the distance to the sensor or installation plane.

In this case, it is particularly advantageous if the distance sensor is a stereo camera with a first sensor and a second sensor, at least one set of distance data which can advantageously be in the form of an image respectively being generated by means of the two sensors.

It is also advantageous if the distance sensor is a time-of-flight sensor or a radar sensor or a lidar sensor which is used to generate at least one set of distance data which may be in the form of at least one image of distance data, for example.

It is also advantageous, in particular, if each of the sensors of the stereo camera generates images which are evaluated in order to automatically determine the height of the arrangement of the apparatus.

In this case, it is advantageous, in particular, if each of the sensors of the stereo camera generates, in successive recording cycles, images which are evaluated in order to automatically determine the height of the arrangement of the apparatus.

The quality of the result can be improved by using a number of images.

It is also advantageous if a disparity map or a disparity map for each recording cycle is generated from the images from the sensors, which disparity map(s) is/are evaluated. In particular, it is advantageous if a disparity map is generated by means of a matching method, which disparity map can be used to obtain distance data on the basis of camera data such as intrinsic calibration data.

In this case, it is also advantageous if an averaged disparity map or distance data is/are generated from the disparity maps or distance data. This makes it possible to improve the quality of the result.

It is also expedient if a histogram or a frequency distribution is generated from a set of acquired distance data or from a plurality of sets of acquired distance data or from the averaged distance data. This makes it possible to evaluate the frequency of the measured distance data. In this manner, the observed environment of the apparatus can be statistically evaluated in terms of the distance between the observed environment and the sensor or installation plane. The frequency distribution is a distribution, in particular a continuous distribution, of distance data, the distance data advantageously containing values relative to the sensor or installation plane, and the number of occurrences also being added. The histogram is likewise a distribution of distance data, the distance data advantageously containing values relative to the sensor or installation plane, but the sum of discredited bins of distance ranges is formed.

The frequency distribution and histogram in the sense of the method therefore contain height data which could all potentially correspond to the installation height. The aim of the method is to determine the correct value from these different heights.

It is also expedient if a histogram or a frequency distribution of the height data is generated from a disparity map or from the disparity maps or from the averaged disparity map. This makes it possible to statistically evaluate the observed environment of the apparatus in terms of the distance between the observed environment and the sensor or installation plane in a resource-optimized manner.

It is also expedient if the histogram or frequency distribution is evaluated in such a manner that it is possible to determine an item of height information relating to a maximum height which can be output. At best, this maximum height is the height of the arrangement, that is to say the installation height, of the apparatus, which needs to be determined.

In this case, it is advantageous if the distance data, the disparity map, the histogram and/or the frequency distribution is/are subjected to a quality analysis in order to determine the height information relating to a maximum height, the height advantageously denoting the distance to the sensor or installation plane and the determined height information being output if predefined quality criteria are satisfied and/or an error message being output if the quality criteria are not satisfied.

It is likewise expedient if the distance data or the averaged distance data and calibration data and/or position angles of the apparatus are used to determine or calculate the histogram or frequency distribution. In this case, the result of the calculation can be transformed from a camera coordinate system KKS to a world coordinate system WKS.

It is likewise expedient if the disparity map or the averaged disparity map and calibration data and/or position angles of the apparatus are used to determine or calculate the histogram or frequency distribution. In this case, the result of the calculation can be transformed from a camera coordinate system to a world coordinate system.

In particular, it is advantageous if the coordinate transformation is carried out without translation. This has the advantage that this enables coordinate transformation to a world coordinate system without knowing the height of the arrangement of the apparatus.

It is also advantageous if the histogram is normalized. The result of the histogram or frequency distribution can therefore be compared with other histograms since respectively normalized data can be compared.

It is also advantageous if the histogram is created using all valid values in the vertical direction. In particular, it is advantageous if the histogram or frequency distribution is determined using all valid disparity values.

It is particularly advantageous if the size of the bins of the histogram or frequency distribution can be parameterized. This makes it possible to set the resolution of the method depending on the size of the bins.

It is also advantageous if the histogram or frequency distribution is smoothed. This can be carried out, for example, by setting less relevant bins to 0 and/or setting unrealistically high values to a maximum value. As a result, the more clearly pronounced bins are given a stronger emphasis and the so-called background noise of the less pronounced bins is reduced. Evaluation methods are therefore simplified if irrelevant bins do not interfere.

In this case, it is advantageous if the maximum height value of the histogram can be parameterized. This makes it possible to stipulate an upper limit of the method which may depend on the boundary conditions of the sensors used.

It is likewise also advantageous if the minimum height value >0 of the histogram can be parameterized.

It is therefore also advantageous if the histogram or frequency distribution is evaluated in such a manner that it is examined for large height values.

It is also advantageous if the histogram or frequency distribution is evaluated in such a manner that a check is carried out in order to determine whether a bin under consideration or a frequency value under consideration represents an accumulation of identical distances at the greatest possible distance from the camera plane.

It is also advantageous if the histogram or frequency distribution is evaluated in such a manner that a check is carried out in order to determine whether a bin under consideration or a value under consideration represents a maximum.

It is likewise expedient if the histogram or frequency distribution is evaluated in such a manner that a check is carried out in order to determine whether a bin under consideration reaches a threshold value.

It is therefore also advantageous if the histogram or frequency distribution is evaluated in such a manner that a check is carried out in order to determine whether a bin under consideration reaches a considerably higher value than its two second neighbors.

In this case, it is also advantageous if the question of whether a bin h(i) under consideration reaches a considerably higher value than its two second neighbors (h(i−2), h(i+2)) is checked in order to determine whether the following applies: h(i−2)+h(i+2)/2*h(i)>a limit value.

It is also particularly advantageous if the quality of a maximum is checked. In particular, it is advantageous in this case if the average value and the standard deviation of the maximum are determined. For this purpose, it is possible to consider a Gauss curve which approximates the profile of the histogram or frequency distribution forming the maximum.

It is also particularly advantageous if a standard deviation is determined for an environment of a determined maximum and is compared with a threshold value.

The object with respect to the apparatus is achieved with the features of claim 29 or 30.

One exemplary embodiment of the invention relates to an apparatus for sensing and/or counting moving objects such as persons, in particular, having a distance sensor, the distance sensor generating distance data, in particular as the distance between the apparatus and an environment of the apparatus, which are evaluated in order to automatically determine the height of the arrangement of the apparatus, in particular for carrying out a method according to the above embodiments for automatically determining the height of the arrangement of the apparatus, in particular with respect to a floor area.

Another exemplary embodiment of the invention relates to an apparatus for sensing and/or counting moving objects such as persons, in particular, having a stereo camera with a first sensor and a second sensor, in particular for carrying out an above method for automatically determining the height of the arrangement of the apparatus, in particular with respect to a floor area.

Further advantageous configurations are described by the following description of the figures and by the subclaims.

### BRIEF DESCRIPTION OF THE DRAWINGS

The invention is explained in more detail below on the basis of at least one exemplary embodiment using the drawings, in which:

FIG. 1 shows a schematic illustration of an apparatus for counting moving objects,

FIG. 2 shows a schematic illustration of an arrangement of such an apparatus,

FIG. 3 shows a schematic illustration of an arrangement of such an apparatus,

FIG. 4 shows a block diagram for explaining the invention,

FIG. 5 shows an illustration for explaining the method according to the invention,

FIG. 6 shows an illustration for explaining the method according to the invention,

FIG. 7 shows an illustration for explaining the method according to the invention,

FIG. 8 shows an illustration for explaining the method according to the invention, and

FIG. 9 shows an illustration for explaining the method according to the invention.

### PREFERRED EMBODIMENT OF THE INVENTION

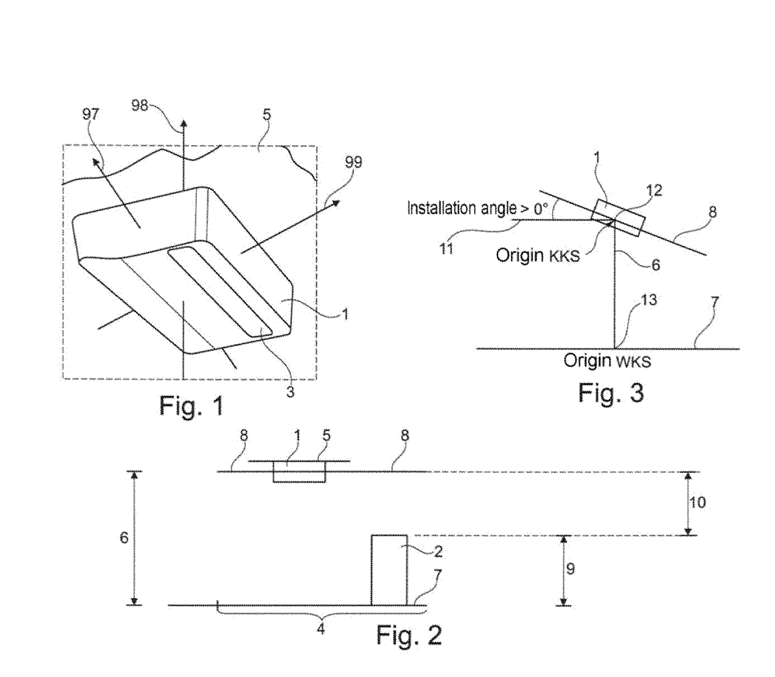

FIGS. 1 to 3 each show a view of an apparatus 1 for sensing and/or counting moving objects 2 such as persons, in particular. In this case, the apparatus 1 is provided with a sensor device 3 which can be arranged, for example, in an entrance area of a salesroom or the like and monitors a monitored area 4 as the room area and detects moving objects 2 therein and counts them according to previously stipulated criteria, for example. In this case, the sensor device is advantageously a distance sensor which can measure at least a distance. In this case, however, the distance sensor can advantageously record not only a distance, but rather an entire 3-D point cloud or a set of distances or distance data.

It is possible to see a sensor device 3 which is set up to observe the monitored area 4. In the present exemplary embodiment, the sensor device 3 is in the form of a stereo camera. Alternative sensors, in particular optical sensors or cameras, can also be alternatively used such as a time-of-flight sensor or a lidar sensor, a radar sensor or the like. The sensor device 3 may also have a combination of a plurality of respectively identical or different cameras or sensors. These are preferably optical sensors. A control and computing unit is also provided and is preferably arranged in the sensor device 3 and is connected to the sensor device 3.

In the exemplary embodiment in FIGS. 1 and 2, the apparatus 1 is arranged on a ceiling 5 or an upper surface of the monitored area. In this case, the apparatus may also be arranged on an installation apparatus which can be installed on the ceiling or wall, for example. Alternatively, the apparatus 1 may also be installed on a stand provided for this purpose.

In this case, the apparatus can be used to carry out a method for determining the height of an arrangement of the apparatus for sensing and, in particular, counting moving objects. In this case, the apparatus is equipped with a distance sensor which monitors the environment of the apparatus. The sensor, such as the distance sensor, generates distance data, in particular as the distance between the apparatus and an environment of the apparatus, which are evaluated in order to automatically determine the height of the arrangement of the apparatus. In this case, however, the sensor as such cannot distinguish what should be measured as the floor or what should be measured as an object, in particular a static object. The data from the sensor should be evaluated accordingly in order to be able to determine the height of the arrangement of the apparatus. However, it is advantageous in this case if the distance sensor captures at least one part of a floor above which the apparatus is arranged. As a result, the distance to the apparatus can then be interpreted as the height.

In this case, the distance sensor generates, in successive recording cycles, distance data which are evaluated in order to automatically determine the height of the arrangement of the apparatus. In this case, a plurality of measured distance data items are advantageously evaluated in order to determine the height of the arrangement of the apparatus, the measured distance data being evaluated in such a manner that the respective frequency of the occurrence of distance values is evaluated in order to determine the height of the arrangement of the apparatus.

The respective frequency of the occurrence of the measured maximum distance values of the distance data can likewise be evaluated. The respective frequency of the occurrence of the maximum distance values of the distance data can also be evaluated in relation to the frequency of the occurrence of other distance data with lower distance values in order to determine the height of the arrangement of the apparatus. In addition, a plurality of measured distance data items may be evaluated in order to determine the height of the arrangement of the apparatus, the height of the arrangement of the apparatus corresponding to that distance value in the distance data which has the maximum distance value for the maximum frequency of the occurrence of this distance value. If the distance data are not in the form required for the height in this case, the height of the arrangement of the apparatus can be determined from that distance value in the distance data which has the maximum distance value for the maximum frequency of the occurrence of this distance value.

The sensor device 3 is set up to record a sequence of images of the monitored area 4. The object 2, for example in the form of a moving person, typically moves in the monitored area at a speed of approximately 1 m/s. An exposure time and an image recording rate of the sensor device 3 are adapted to this speed. The image recording rate of the sensor device 3 may be approximately 20 Hz, for example, and the exposure time of an individual image in the sequence of images is 40 ms, for example. It is also possible to select other values for the image recording rate and the exposure time depending on what brightnesses and/or movement speeds are expected in the monitoring area and what boundary conditions are present. Alternatively, the object 2 may be a static object, for example a table, which cannot be distinguished from the floor on the basis of the change in the distance data in a plurality of successive recording cycles.

FIG. 2 shows the apparatus 1 on a ceiling 5 at an installation height 6 from a floor plane 7. In this case, the installation height 6, or also simply called only height 6, is the height 6 between a floor plane 7 and a camera plane 8 of the apparatus 1. In this case, the determination of the height 6 by means of the camera plane 8 is entirely sufficient since the plane of the recording sensor as the camera plane 8 of the apparatus 1 is generally decisive for determining the height. If a height to the ceiling 5 as the installation height is intended to be used instead, this can also be derived from the height of the camera plane since the distance between the camera plane and the ceiling plane is known in the case of ceiling installation.

An object 2 with an object height 9 is also provided and can be detected. In this case, the object distance 10 to the camera plane 8 can also be determined. If the height 6 is known, the object height 9 can also be determined.

For this purpose, the stereo camera provides the relevant distances to the camera plane 8, that is to say the distance 6 as the floor distance and the object distance 10 to the camera plane 8. In order to therefore determine the object height 9, it is sufficient if the distance 10 is subtracted from the installation height.

In one exemplary embodiment, it can be assumed that the apparatus 1 is in an aligned position with both position angles or installation angles=0°. Alternatively, these can also be determined. In this case, the position angles or installation angles are the two angles which define the position of the camera plane with respect to the floor plane. FIG. 3 depicts, for example, a position angle of the camera plane 8 with respect to the installation plane 11 in a 2-D view. The installation plane 11 is the horizontal or may alternatively be a plane parallel to the floor plane if the floor plane is not parallel to the horizontal. In this case, a distinction is typically made between a camera coordinate system KKS and a world coordinate system WKS. The camera coordinate system KKS has its origin 12 in the area of the camera or the apparatus 1. The world coordinate system WKS advantageously has its origin 13 on the floor below the apparatus. In order to also be able to determine the height 6 with respect to each point of the floor plane in one exemplary embodiment according to FIG. 3, it is therefore advantageous to acquire the distance data taking into account the two position angles. The distance data are then available in a world coordinate system WKS, the origin of which, however, is initially in the area of the sensor, the camera or the apparatus 1. The camera coordinate system is on the installation plane. Only after the height has been determined can the data be shifted to a world coordinate system WKS with an origin 13.

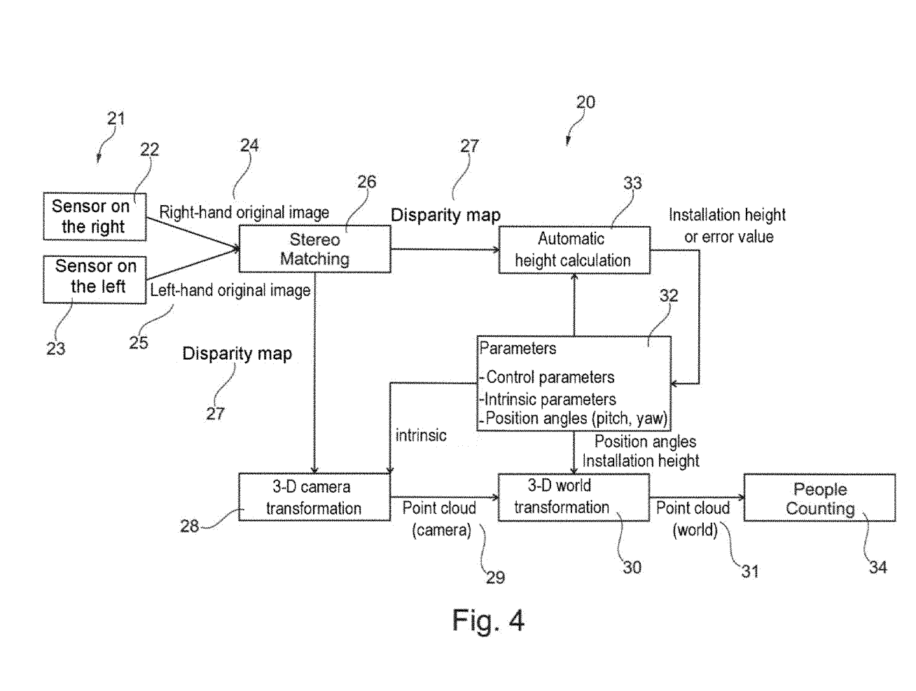

FIG. 4 shows a block diagram for explaining the invention. The apparatus 20, also called monitoring or person counting device, advantageously has a stereo camera 21 with a right-hand sensor 22 and a left-hand sensor 23. The images from the two sensors 24, 25 are handled using a stereo matching method, see block 26.

In order to be able to count moving objects or persons, they first of all need to be detected and, upon detection, they need to be distinguished from other, rather unimportant objects. One feature of a plurality of features of persons which distinguishes a person from other objects is the size or height thereof from the floor. The size is accordingly suitable for distinguishing persons from low flat objects, for example from the floor or from boxes etc., and for being able to sense children separately from adults, for example. The stereo camera 21 makes it possible to calculate three-dimensional information from the observed scene. The size of objects can be determined from this 3-D point cloud. The size of objects is defined as the distance between the highest visible point on the object and the floor. The floor therefore has a size of 0 by definition.

Two 3-D coordinate systems are used in the processing chain: the camera coordinate system (KKS) and the world coordinate system (WKS). In order to determine the size of objects, 3-D data are required in the WKS. For this purpose, there is a process module such as a software module which calculates a disparity map 27 in each video frame. A 3-D point cloud 29 can be calculated in the KKS from the disparity map 27 and possibly data relating to intrinsic calibration such as the base distance, focal length, center of the image (principal point) etc., see block 28. This 3-D point cloud 29 is transformed into a 3-D point cloud 31 in the world coordinate system WKS with the aid of external calibration 32, for example with position angles and the installation height, see block 30. The height of the apparatus can therefore also be automatically calculated in block 33, the result entering block 32 for transformation and calibration.

In this case, it is advantageous if the automatic calculation of the height of the apparatus is called only during installation and the remaining chain, blocks 26, 28, 31, 31 and 34, according to FIG. 4 is carried out during ongoing operation in each frame.

As a result of the transformation, the 3-D data are transformed from the KKS to the WKS, see block 30. External calibration is required for this purpose, the external calibration being dependent on the installation position and position of the apparatus. In this case, the installation position is defined by the position angles “pitch”, “yaw” and possibly “roll” of the apparatus 1 and the installation height, also see FIG. 3. In this case, the yaw angle is the angle of a rotation about a longitudinal axis 99, the pitch angle is the angle of a rotation about a lateral axis 97 and the roll angle is the angle of a rotation about a vertical axis 98, see FIG. 1. The roll angle can be advantageously assumed to be 0. In block 34, the detected objects, such as persons, are counted. Alternatively, the type, the duration of the stay, a queue length, a hazardous situation or more can be detected in block 24.

The external calibration can be carried out once during start-up here. In this case, the angles can either be entered manually or can be automatically sensed with the aid of an installed acceleration sensor.

The method according to the invention relates to automatic determination of the installation height with the aid of an imaging method by means of the apparatus 1 itself.

Automatic measurement of the angles and installation height has the advantage that the external calibration can be automatically carried out. The manual determination of the installation angles and the installation height is therefore no longer required.

Since the stereo camera in the apparatus is already provided for the purpose of sensing and/or counting the objects or persons, an additional, further sensor for measuring the distance does not need to be provided.

The data are advantageously converted here from the camera coordinate system KKS to the world coordinate system WKS by:

w=R*c+t

where:

c=3-D camera coordinates, w=3-D world coordinates, R=rotation matrix determined by position angles, and t is a vector in world coordinates which comprises the installation height.

The method according to the invention is based on the fact that the height of the arrangement of the apparatus is automatically determined and on the fact that substantially all measured distances, in particular to the installation and camera planes, are considered in this case and are examined for a significant accumulation of the same heights at the greatest possible distance to the camera plane.

In this case, the method according to the invention is carried out electronically, that is to say it is controlled by a software module in a control unit of the apparatus.

The method for automatically determining the height is carried out in this case, in particular, after the apparatus has been installed. In this case, the result of the determination of the height can be output on a display, for example, with the result that the installer can check this determined height and can accept or reject it. In this case, the method can be called once, for example, by the installer in the HMI (Human Machine Interface) after or during installation of the apparatus. When called, the method carries out the method described below and returns the installation height as the result. If the method could not determine a height, an error value, for example the display “not available”, is returned.

In order to carry out the method, the following input data are provided, in particular: a height map or a disparity map, data relating to internal calibration, and the position angles. If the method is successfully carried out, the installation height of the apparatus is output as the output of the method and an error value is output in the event of failure.

The method can now be carried out, for example, in the following manner:

An image is respectively recorded using the sensors 22, 23 of a stereo camera and the disparity map is calculated. Optionally, noise suppression can then be carried out. Instead of the disparity map, it is also possible to work directly on the distance data. This shall not always be mentioned below since the methods used are substantially the same.

A histogram is then created. The histogram is then analyzed for valid maxima (peaks) which are analyzed, and the determined height of a maximum with maximum height is output. Alternatively, instead of a histogram, a frequency distribution can also be created and used for further processing. Since the subsequent method is carried out in substantially the same manner, this exemplary embodiment shall start from the creation of a histogram.

A temporal averaging method can be optionally carried out over a plurality of disparity maps for noise suppression. A histogram or a frequency distribution with improved quality can be created on the basis of the improved disparity map. Alternatively, it is also possible to optionally use a different noise suppression method.

The temporal averaging method averages the received disparity maps (DK) over a short period, for example 1/20 s frames. In this case, a disparity map is received in each frame. This would accordingly be 20 disparity maps at a sampling rate of 20 Hz in 1 second.

In this case, each pixel d of the disparity map is averaged over this period of 1 s, for example by an arithmetic mean. If fewer than k valid values have been received in this case, the pixel is set to 0, that is to say as invalid, in the averaged disparity map:

$$d ( i , j ) = \frac{1}{n} {\sum }_{n}^{ } {d}_{n} ( i , j )$$

$$if$$

$$\vert \{ {d}_{n} ( i , j ) \vert {d}_{n} ( i , j ) > 0 ∀ n = 1 … N \} \vert \geq k$$

$$else$$

$$d ( i , j ) = 0$$

In this case:

d(i,j) is the averaged pixel d at image position (i,j),

dₙ is the disparity map at the time n,

N is the number of disparity maps which are averaged,

k is a threshold value <N.

An integral disparity map is assumed in the exemplary embodiment.

The value “0” in a disparity map in this exemplary embodiment also means an “invalid value”. Alternatively, an invalid value can also be indicated in a different manner.

The result is an averaged disparity map.

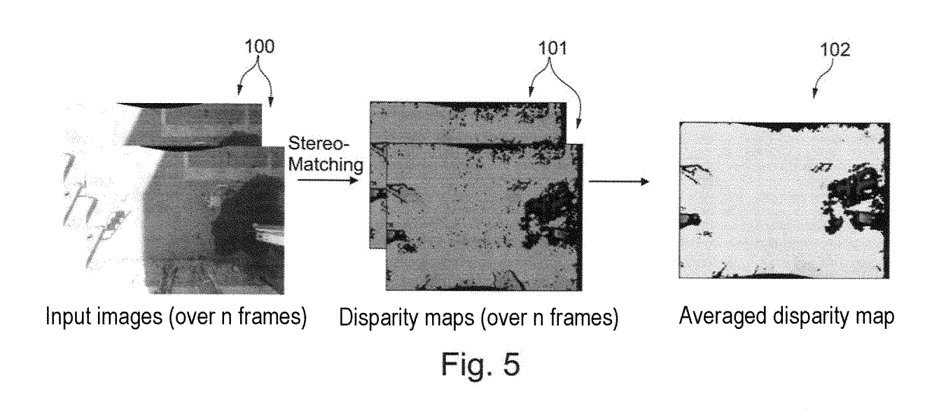

Based on FIG. 4, FIG. 5 shows a plurality of input images 100 (over n frames) of the stereo camera 21, as recorded by the sensors 22, 23. A stereo matching method generates corresponding disparity maps 101 (over n frames). An averaged disparity map 102 is generated from the different disparity maps 101 by means of the averaging method described above, for example.

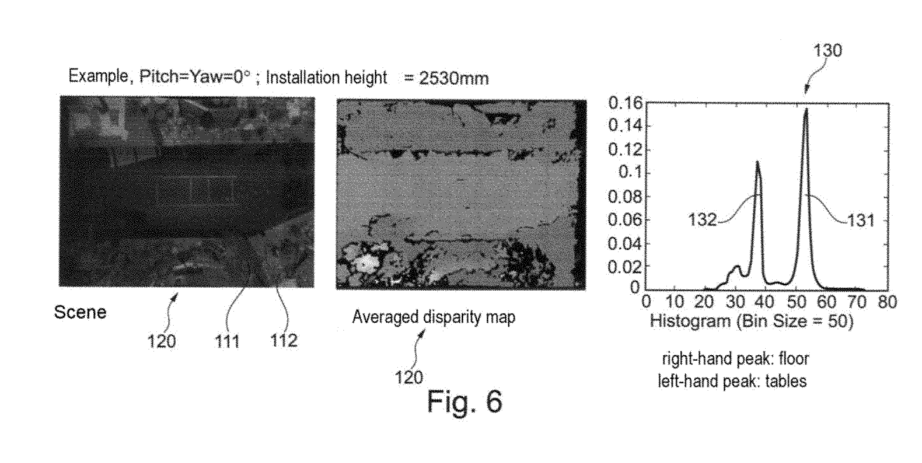

FIG. 6 shows, in the left-hand partial image, a scene of a room 110 with a floor 111 and tables 112. The recording was carried out using an apparatus which is arranged at an installation height of 2530 mm at a pitch angle and a yaw angle of 0.

An averaged disparity map, data relating to the intrinsic calibration and data relating to the position angles (pitch, yaw) are used, as input data from this recording or a plurality of recordings, to calculate the histogram.

A histogram 130, preferably a normalized histogram, is generated as the output. In this case, the histogram 130 shows two maxima 131, 132 at different height values on the horizontal axis. The right-hand maximum 131 with the greater height on the horizontal axis is the maximum for the floor which is arranged at the corresponding distance from the apparatus, and the maximum 132 is the maximum assigned to the tables, the tables being arranged at a lower height on the horizontal axis with respect to the apparatus since they are arranged above the floor. In this case, the maximum 131 for the floor has a higher frequency on the vertical axis and the maximum 132 for the table has a lower frequency on the vertical axis. If the monitoring area were selected in such a manner that more of the tables could be seen, the right-hand maximum 131 for the floor would be less pronounced owing to the lower frequency and the maximum 132 for the table would be more pronounced owing to the higher frequency. In both cases, the method according to the invention would select the correct maximum for determining the height.

The method determines a histogram from the data as follows, for example:

1. The averaged disparity map is transformed into a 3-D point cloud in the camera coordinate system with the aid of the intrinsic calibration.

2. The rotation matrix is calculated from the position angles with the aid of trigonometric functions.

3. The 3-D points are transformed into world coordinates, in particular non-translated world coordinates, according to WKS (see above) by means of multiplication by the rotation matrix R.

4. It is then assumed that the y coordinate of these world points contains the distance to the camera plane.

5. A histogram is created using substantially all valid y coordinates. In this case, valid y coordinates are, by definition, those in which the disparity is valid (>0).

6. The size of the bins of the histogram can be optionally parameterized, for example 50 mm.

7. The maximum height value which can be binned by a histogram can be optionally parameterized, for example 8000 mm.

8. Sparsely populated, that is to say insignificant, bins are optionally set to 0 in order to illustrate the result.

h(b)=0 if h(b)<binLimit, where h(b): number of hits for bin b; binLimit can be parameterized, for example 1000.

9. The corrected histogram can optionally be normalized. This makes it easier to compare different histograms with one another, which facilitates a quality check, for example.

In an alternative exemplary embodiment in which the distance data relative to the installation plane are already available, steps 1 to 3 can also be omitted in this method. It is also possible that, in an alternative embodiment, the distance data used to calculate the height are not in a y coordinate, but rather have been stored in a different manner. The method can nevertheless be otherwise carried out in the same manner. In step 6, it is advantageous to select the size of the bins to be greater than the expected noise of the height values. If the size of a bin is 50 mm, this means that the frequency corresponds to the number of all values in a height range, for example 150 mm-200 mm. In order to create the histogram, the number of measured values is determined and plotted for each height range. Steps 7-9 comprise further optional smoothing of the histogram. Alternatively, a different smoothing method can also be used or no smoothing can be carried out.

FIG. 6 shows an example of such a normalized histogram. In this case, the frequency is normalized from 0 to 1. The bin size is 50 mm. The right-hand maximum is approximately at bin 51. If this bin is multiplied by the bin size of 50 mm, approximately the installation height is obtained as the result: 51*50 mm=2550 mm.

The histogram from FIG. 6 is advantageously present in discretized form, rather than continuously. If the bin size in FIG. 6 were greater, the staircase shape caused by the discretization could be clearly discerned from the figure. In this case, the size of the bins depends on the resolution of the discretization. Alternatively, however, the histogram may also be present continuously, that is to say as a frequency distribution.

During analysis of the histogram, a normalized histogram and the number of samples may be available as input values. In this case, the number of samples advantageously corresponds to the number of valid disparity values.

The approximated installation height can be output as the output of the analysis; otherwise, an error value is output.

The method according to the invention also has the approach of finding a maximum with the greatest height value in the histogram.

In this case, it is optionally possible to carry out at least one quality check which involves discerning whether the quality of the histogram and of the maximum found suffices to accept the approximated installation height of the apparatus or whether it should be rejected and an error value should be output instead as the output.

In this case, it is advantageous to first of all check the quality of the input data. An example of such a check is the determination of the number of samples (valid input values). If this number is lower than a threshold value, for example 2000, there is insufficient quality. In the event of insufficient quality, it is advantageous to abort the method and return an error value.

In order to carry out the method according to the invention, it is possible to use any method for finding a local maximum. It is also advantageous to use an optimization method which simultaneously finds both a particularly pronounced maximum and a maximum at great height values. For this purpose, a search is advantageously carried out for all local maxima in the histogram and their pronounced nature and/or quality is/are checked. The maximum which is the best candidate overall is then used to determine the height. Alternatively, it is possible to select an embodiment variant in which a quality limit is defined. In such a case, the maximum with the greatest height values which complies with this quality limit is selected. This has the advantage that not all maxima have to be checked, thus saving resources.

In such an embodiment variant, the method has the step of running through the histogram from large values to small values in order to determine a maximum. As a result, the local maximum with the greatest height values is found first. This is advantageous if it is assumed that the maximum sought is intended to be at the greatest height.

In one manner of execution, a check is carried out for each bin in order to determine whether there is a local maximum for the current bin b. This can be checked by checking whether h(b)>h(b−1) and h(b)>h(b+1); if not, the check is repeated for the next bin.

If a local maximum is found, it is advantageous to check whether the quality of the maximum is sufficient. If this is not the case, the next maximum, that is to say the maximum with the next lower height, is checked.

As a quality limit, properties of maxima can be checked in this case and compared with threshold values. In particular, the width, the height and the properties in comparison with the surrounding maxima or the data overall can be determined.

One example is that a fixed height threshold value is queried. In addition, it is advantageous to select the height threshold value on the basis of the average height in the histogram. This quality check checks whether the detected floor constitutes a minimum portion in the image. It also therefore stipulates the portion of visible floor in the image from which the height can be determined in sufficient quality. In this case, it is also useful that the average height must not only be exceeded but rather is intended to be considerably higher, that is to say, for example, by a factor. It is therefore possible to check, for example, whether h(b)>peakValLimit, in which case a determination is carried out by counting the number of bins b for which h(b)>0, and the parameter HistoValidPeakFactor (for example 2.5) is divided by this value and the result is stored in “peakValLimit”. In this case, HistoValuePeakFactor is the factor by which there should be a deviation from the average.

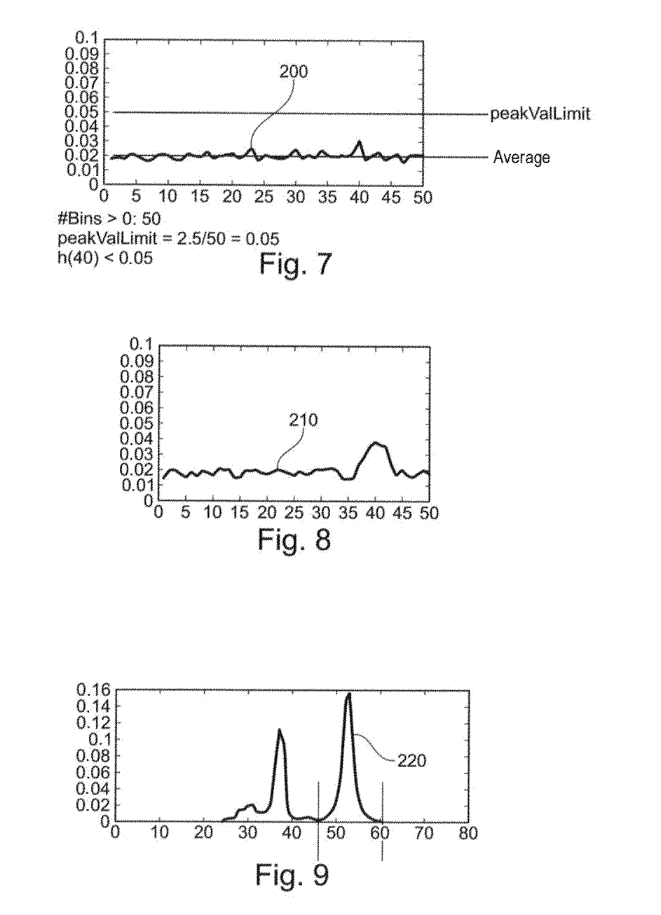

FIG. 7 shows an example of this. A profile according to line 200 can be seen in FIG. 7. All shown maxima of the line 200 are approximately at the value of the average, in which case individual local maxima are higher than the average. However, none of the values is also greater than or equal to the value peakValLimit, as can be seen in FIG. 7. Accordingly, it would not be possible to identify a clearly discernible local maximum.

It is optionally also possible to provide a quality check in which it is queried whether the maximum has a considerably higher value than its two second neighbors. It is therefore queried whether the following inequality is satisfied for a peak at the location (bin) i: if (h(i−2)+h(i+2))/(2*h(i))>histoMinRelDiffToNeighbor (for example 0.75). Alternatively, it is also possible to take the two first neighbors. However, the check of the two next neighbors is advantageous since a maximum often extends to two or three bins and the quality check would fail in such a case even though there is a maximum which is clearly pronounced in comparison with the direct environment. Alternatively or additionally, further neighbors may also be checked.

This is intended to exclude maxima which are not pronounced.

FIG. 8 shows an example of this. A profile according to line 210 can be seen in FIG. 8. All shown maxima of the line 210 are rather very broad and are not very sharp. A considerably pronounced maximum therefore could not be determined.

The step of outputting an error value if the last test was also unsuccessful is also provided.

If this was not the case, a suitable local maximum was identified.

Additionally or alternatively, the quality of the maximum/maxima can be analyzed in the following manner. For this purpose, the region around the maximum can be considered as a Gauss curve and its standard deviation (stdHeight) can be calculated. The standard deviation can be tested against a threshold value (stdHeightMax).

In order to determine the starting point and end point of the Gauss curve, the histogram is run through to the left or right, starting from the maximum, and the location at which the left-hand or right-hand neighbor is either 0 or has a higher value than the predecessor is noted.

It may be the case that the threshold value stdHeightMax is not constant, but rather depends on the installation height of the apparatus itself, for example. This is comprehensible at least because a stereo camera measures more inaccurately, the further away it is from the measured object. Other parameters which can influence the measurement accuracy of the stereo camera and therefore the threshold value stdHeightMax are the focal length, the base distance, the installation angles and the size of the bins of the histogram.

FIG. 9 shows an example of this. A profile according to line 220 can be seen in FIG. 9. Two maxima are seen, in which case the Gauss curve of the right-hand maximum is determined by the two vertical lines. In this case, the extent of the width of the Gauss curve, that is to say its standard deviation, can be considered to be a good measure of the quality of the maximum.

For this purpose, the value of stdHeightMax as the threshold value for the standard deviation can be calculated using the following formula:

$$stdHeightMax = \frac{{z}^{2}}{f \times b} \times d \times c + 0.5 \times s$$

where:

z: avrgHeightCam=the average height of the apparatus in camera coordinates=avrgHeight*cos(pitch)*cos (yaw)

f: focal length

b: base distance

d: parameter; error of the stereo method during disparity calculation (for example ⅙)

c: parameter (for example 2.5)

s: bin size of the histogram.

If the calculated standard deviation of the Gauss curve stdHeight is less than the threshold value stdHeightMax, the quality of the maximum is sufficient and otherwise there is an error value.

If the optimum maximum or a maximum of sufficient quality is found, the height value associated with the maximum in the histogram or frequency distribution will be output as the actual height value of the arrangement of the apparatus. In this case, no conversion whatsoever is required if the distance value relative to the installation plane is present. If this is not the case, the above-mentioned transformations must be carried out.

In one embodiment variant, the height value having the maximum frequency is output. Alternatively, it is advantageous to estimate an improved height from the properties of the maximum.

For this purpose, the bin locations over which the Gauss curve extends in the histogram are converted into heights and the average value (avrgHeight) of the Gauss curve is advantageously output as the height.

### LIST OF REFERENCE SYMBOLS

1 Apparatus
2 Object
3 Sensor device
4 Monitored area
5 Ceiling
6 Installation height
7 Floor plane
8 Camera plane
9 Object height
10 Distance
11 Horizontal
12 Origin
13 Origin
20 Apparatus
21 Stereo camera
22 Right-hand sensor
23 Left-hand sensor
24 Sensor
25 Sensor
26 Block
27 Disparity map
28 Block
29 3-D point cloud
30 Block
31 3-D point cloud
32 External calibration
33 Block
97 Lateral axis
98 Vertical axis
99 Longitudinal axis
100 Input images
101 Disparity map
102 Disparity map
110 Room
111 Floor
112 Table
130 Histogram
131 Maxima
132 Maxima
210 Line

1. Method for determining the height of an arrangement of an apparatus for sensing and, in particular, counting moving objects by means of a distance sensor, the apparatus having the distance sensor, the sensor generating distance data, in particular as the distance between the apparatus and an environment of the apparatus, which are evaluated in order to automatically determine the height of the arrangement of the apparatus.

2. Method according to claim 1, wherein the distance sensor senses at least one part of a floor above which the apparatus is arranged.

3. Method according to claim 1, wherein the distance sensor generates, in successive recording cycles, distance data which are evaluated in order to automatically determine the height of the arrangement of the apparatus.

4. Method according to claim 1, wherein a plurality of measured distance data items are evaluated in order to determine the height of the arrangement of the apparatus.

5. Method according to claim 1, wherein the measured distance data are evaluated in such a manner that the respective frequency of the occurrence of distance values is evaluated in order to determine the height of the arrangement of the apparatus.

6. Method according to claim 1, wherein the respective frequency of the occurrence of the measured maximum distance values of the distance data is evaluated in order to determine the height of the arrangement of the apparatus.

7. Method according to claim 1, wherein the respective frequency of the occurrence of the maximum distance values of the distance data is evaluated in relation to the frequency of the occurrence of other distance data with lower distance values in order to determine the height of the arrangement of the apparatus.

8. Method according to claim 1, wherein the height of the arrangement of the apparatus corresponds to that distance value in the distance data which has the maximum distance value for the maximum frequency of the occurrence of this distance value.

9. Method according to claim 1, wherein the distance sensor is a stereo camera with a first sensor and a second sensor, at least one image respectively being generated as distance data by means of the two sensors.

10. Method according to claim 1, wherein the distance sensor is a time-of-flight sensor or a radar sensor or a lidar sensor which is used to generate at least one image as distance data.

11. Method according to claim 9, wherein each of the sensors generates, in successive recording cycles, images or distance data which are evaluated in order to automatically determine the height of the arrangement of the apparatus.

12. Method according to claim 1, wherein a disparity map or a disparity map for each recording cycle is generated from the images from the sensors, which disparity map(s) is/are evaluated.

13. Method according to claim 12, wherein an averaged disparity map is generated from the disparity maps and/or averaged distance data are generated from the distance data.

14. Method according to claim 12, wherein a histogram or a frequency distribution of the distance data is generated from a disparity map or from the disparity maps or from the averaged disparity map.

15. Method according to claim 14, wherein the histogram or frequency distribution is evaluated in such a manner that it is possible to determine an item of height information relating to a maximum height which can be output.

16. Method according to claim 15, wherein the histogram or frequency distribution is subjected to a quality analysis in order to determine the height information relating to a maximum height, the determined height information being output if predefined quality criteria are satisfied and/or an error message being output if the quality criteria are not satisfied.

17. Method according to claim 13, wherein the disparity map or the averaged disparity map and calibration data and/or position angles of the apparatus are used to determine or calculate the histogram or frequency distribution.

18. Method according to claim 13, wherein the histogram or frequency distribution is normalized.

19. Method according to claim 13, wherein the histogram is created for all valid values in the vertical direction.

20. Method according to claim 13, wherein the size of the bins of the histogram or frequency distribution can be parameterized.

21. Method according to claim 13, wherein the maximum distance value or height value of the histogram or frequency distribution can be parameterized.

22. Method according to claim 13, wherein less relevant bins are set to 0.

23. Method according to claim 15, wherein the histogram or frequency distribution is evaluated in such a manner that it is examined for large distance values or height values.

24. Method according to claim 15, wherein the histogram or frequency distribution is evaluated in such a manner that a check is carried out in order to determine whether a bin under consideration constitutes a maximum.

25. Method according to claim 15, wherein the histogram or frequency distribution is evaluated in such a manner that a check is carried out in order to determine whether a bin under consideration reaches a threshold value.

26. Method according to claim 15, wherein the histogram or frequency distribution is evaluated in such a manner that a check is carried out in order to determine whether a bin under consideration reaches a considerably higher value than its two second neighbors.

27. Method according to claim 26, wherein the question of whether a bin h(i) under consideration reaches a considerably higher value than its two second neighbors (h(i−2), h(i+2)) is checked in order to determine whether the following applies: h(i−2)+h(i+2)/2*h(i)>a limit value.

28. Method according to claim 1, wherein the environment of a determined maximum is compared with a Gauss curve, the standard deviation of which is determined and is compared with a threshold value.

29. Apparatus for sensing and/or counting moving objects such as persons, in particular, having a distance sensor, the distance sensor generating distance data, in particular as the distance between the apparatus and an environment of the apparatus, which are evaluated in order to automatically determine the height of the arrangement of the apparatus, for carrying out a method according to one of the preceding claims for automatically determining the height of the arrangement of the apparatus, in particular with respect to a floor area.

30. Apparatus, in particular according to claim 29, for sensing and/or counting moving objects such as persons, in particular, having a stereo camera with a first sensor and a second sensor, for carrying out a method according to one of the preceding claims for automatically determining the height of the arrangement of the apparatus, in particular with respect to a floor area.
